(19) United States
(12) Patent Application Publication
(10) Pub. No.: US 2006/0112132 A1
(43) Pub. Date: May 25, 2006

(54) Methods, systems and computer readable media for providing customized works

(76) Inventors: Amy Maureen Maguire, Cornelius, NC (US); Desiree Leigh McClimon, Phoenixville, PA (US)

Correspondence Address: KILPATRICK STOCKTON LLP, 1001 WEST FOURTH STREET, WINSTON-SALEM, NC, 27101, US

(21) Appl. No.: 11/243,288

(22) Filed: Oct. 4, 2005

Related U.S. Application Data
(60) Provisional application No. 60/615,516, filed on Oct. 4, 2004.

(51) Int. Cl. G06F 17/00; G06F 7/00

(52) U.S. Cl. 707/102

(57) ABSTRACT

The present invention provides systems and methods for generating, providing and distributing works. In an embodiment, a work may be customized or personalized using information relating to an individual to provide an enhanced educational, entertainment, or other experience for the profiled individual. The present invention also provides works comprising a customized portion.

### RELATED APPLICATIONS

This application claims priority, under 35 USC §119, to provisional U.S. patent application, Ser. No. 60/615,516, filed Oct. 4, 2004, titled “Method for Customized Books and Other Works”. The entirety of this provisional application is hereby incorporated herein by reference.

### COPYRIGHT NOTIFICATION

A portion of the disclosure of this patent document and its attachments contain material which is subject to copyright protection. The copyright owner has no objection to the facsimile reproduction by anyone of the patent document or the patent disclosure, as it appears in the Patent and Trademark Office patent files or records, but otherwise reserves all copyrights whatsoever.

### FIELD OF THE INVENTION

The present invention relates to methods, systems and computer readable media for creating customized works. In an embodiment, the present invention relates to a publishing system and method that uses computerized systems for collecting and evaluating individual-specific data in order to provide individuals with customized or personalized publications on demand.

### BACKGROUND

In education and many other fields there is a need to produce customized or personalized publications. For example, it may be most effective for teaching skills to produce books with student specific information. However, there is no system that can produce customized or personalized publications, including text, illustration, and pages on demand. It may also be useful to produce customized works, including, for example, videos or computer publications including video clips in lieu of or along with static illustrations, for educational or non-educational purposes.

In order to manage customized publications, computer systems have been implemented to provide increased speed and flexibility to users. While these systems have proven to be useful for various purposes, they still have been limited in speed and customization, rather than fully customizable and on demand. Accordingly, tools are necessary for processing user specific information and then providing works with greater customization and personalization on demand to the user, which are customized or personalized for the user on an ongoing basis.

Accordingly, it is an object of the present invention to provide a computerized system for collecting and processing user-specific information and generating customized or personalized written materials and other works for users based on such input and to increase the flexibility and speed of production, while reducing costs and increasing efficiency to the system as well as delivering such customized or personalized works to the user.

### SUMMARY OF THE INVENTION

The present invention provides systems, methods and computer readable media for creating, providing and/or distributing customized or personalized works. The terminology “work” or “works” is used herein in a manner consistent with the US Copyright Office's use. A work includes but is not limited to literary works, visual works, audiovisual works, serials, periodicals, recorded works and/or combinations thereof. A literary work may comprise written/textual material and may further comprise illustrations (visual works).

In an embodiment, the present invention provides literary works, comprising written material and visual works, that increase a child's learning and development through customized or personalized materials which closely target each individual child's needs. In another embodiment, the present invention provides literary works and other works which may be used for non-educational purposes, including entertainment or other non-educational uses.

Embodiments of the present invention develop works with highly customizable text, illustrations, and pages on demand for a user. Embodiments of the present invention may reduce or eliminate the cost of under stocking and overstocking customized pieces and the need for physical storage of printed materials. Embodiments of the present invention also allow for highly customizable and personalizable written materials and other works to more effectively meet the needs of users. Embodiments of the present invention also allow for distribution of the customized or personalized works to a user.

Literary works and other works include, but are not limited to, written materials, illustrations, audio materials, visual materials, audio/visual materials, video games, and/or combinations thereof. Works may also comprise content displayed on a web page, or plurality of web pages, including text, pictures, illustrations, video, audio, and the like. Works may comprise materials for teaching a skill, telling a story, explaining an event or occurrence, managing social or emotional problems, or teaching a task or tasks.

In an embodiment, a system of the present invention comprises at least one template, generally a plurality of templates. Each template comprises information to be conveyed to a recipient of the work. The information may relate to one or more of the following: a skill; a task; a story; an activity; a social situation; an event; an environmental condition; or the like. A written material or work of the present invention comprises a template, or a plurality of templates.

In an embodiment, a template comprises at least one information block, generally a plurality of information blocks. Information blocks may be substituted in or out of a template, or exchanged among templates to provide customized works. In an embodiment of the present invention, an information block may be customized based an individual's profile comprising data relating to the profiled individual's physical information including, but not limited to, gender, ethnicity, eye color, skin color, hair style; hair color; use of glasses; communication method; the profiled individual's personal information including, but not limited to, name, favorite food, favorite clothing, school grade, bedtime, toys, playthings, playmates, name of the individual's school, where the individual lives, friends, relatives, care givers, instructors, therapists and other individuals who have a relationship with the profiled individual, and further including identifying information relating to those individuals such as name, age, and other traits; the profiled individual's feelings including, but not limited to, things that make the profiled individual happy, strategies for coping when the individual is anxious, things that cause the profiled individual to be afraid, and strategies for coping when the individual is angry; the profiled individual's social information including, but not limited to, a word or phrase the profiled individual uses when angry or frustrated, a positive thing the profiled individual could say about himself or herself to peers, something the profiled individual does alone, and choices the profiled individual must make frequently; daily routines and rules the profiled individual has or deals with including, but not limited to, the name of the profiled individual's teacher, a community place the profiled individual goes to regularly, a big change the profiled individual is dealing with, and school rules; safety information the profiled individual deals with or should know including, but not limited to, where the profiled individual should go if there is a fire drill, other things the profiled individual should do when encountering a drill or natural disaster, something the profiled individual likes and would be tempted to go with a stranger to have, and toys or treats the profiled individual can use to play with or give to a known pet; seasonal information including, but not limited to, the profiled individual's family's holiday traditions, who is usually at holiday functions, where the profiled individual will stay on vacation, activities the profiled individual does at camp, and where the profiled individual is going on a field trip; and health information including, but not limited to, the profiled individual's doctor's name, medicines or behavior the profiled individual should use when sick, the kind of bathing the profiled individual does, and a specific thing the profiled individual is working on for self-care. This list is not exhaustive and other categories, issues, or information may comprise data in an individual's profile. In addition embodiments of the present invention may utilize information blocks relating to a profiled individual's physical surrounding. Such information blocks include, but are not limited to, geographic features; architectural features; colors; styles; furniture; decor; landscape and the like relating to a profiled individual's physical surrounding.

In an embodiment, the profiled individual may represent a child. The data may be obtained directly from the individual, through interaction with a teacher, parent, counselor or person in a similar role, or through another method. More details relating to these data, templates, information blocks and the customization of works are set forth below.

A system of the present invention may be advantageously implemented either in a stand-alone apparatus or over a computer network. In an embodiment, a system of the present invention comprises a server accessible over a network; and a client device capable of accessing the server over the network. The server may comprise, or communicate with, a database. The database may comprise template data relating to the templates; data relating to the information blocks; data relating to the factors; and related data. The client device may comprise a user interface, for example a graphical user interface; and an input apparatus to allow the inputting of data, such as the factors set forth above and/or similar data utilized to generate information blocks. In an embodiment, the server and the client device may be networked via the World Wide Web or the Internet.

A work of the present invention may be substantially complete, or may be in a form that allows for further customization by a user. For example, a work of the present invention may comprise line drawings that allow for illustration by a user. In another example, a work of the present invention may comprise illustrations that have already been colored so no further action by the user is needed.

In another aspect, the present invention provides computer readable media. In an embodiment, computer readable media of the present invention comprise program code for implementing steps of a method of the present invention.

More details relating to systems of the present invention and computer hardware and software for implementing a system of the present invention are set forth in the following section.

In an embodiment, the present invention provides methods for requesting and storing customized or personalized data about the profiled individual. In an embodiment, the present invention provides a method for presenting questions to be answered by the user about the profiled individual. The present invention is capable of storing the customized or personalized data contained within the responses to the questions. In an embodiment, the present invention may be capable of comparing a question or a plurality of questions with stored customized or personalized data about the profiled individual and determine whether the response is unique or duplicative. In one embodiment, the present invention may eliminate the duplicative response or may not pose the question to the user. In another embodiment, the present invention may replace the stored customized or personalized data with the duplicative response.

The present invention also provides methods for creating, providing and/or distributing works. In an embodiment, the present invention provides a method for creating a work comprising providing a template, the template comprising at least a portion capable of being populated with customized or personalized data; and populating the portion of the template capable of being populated with the customized or personalized data to create a work. The information used in populating the template may comprise information collected from a user about a profiled individual, such as the factors set forth above. Thus, in an embodiment, a method of the present invention for creating a work may further comprise collecting information from a user about a profiled individual relating to the factors as described above and populating the template with at least a portion of the information. The user may be the intended recipient of the work (e.g. the student); a caregiver for the intended recipient of the work, the trainer/instructor (e.g. the teacher); a parent or family member of the intended recipient; a person or persons giving the work as a gift to the intended recipient; other professionals, such as psychologists, speech therapists, behavior therapists, occupational therapists, social workers, administrators, doctors, dentists, hygienists, or any other professional or personal care giver; or someone with a similar relationship to the intended recipient of the work. The work may comprise the work and types of works set forth above.

In an embodiment the present invention provides a method for providing a work to a user, the method comprising receiving input from the user; creating a work responsive to said input; and providing the work to the user. The input may comprise information relating to the type of work desired by the user. The input may also, or further, comprise information relating to an intended recipient of the work.

In an embodiment, the present invention provides a method for distributing a work, the method comprising receiving input from the user about a profiled individual relating to the desire for a work and distributing the work to the user. The methods of providing a work, and/or distributing a work, may further comprise the steps set forth in a method for creating a work.

In an embodiment, the present invention provides a method for displaying or printing the work distributed to the user. The user may, for example, view the work on a display device, personal digital assistant, or other electronic device, and be given the option to print the work to a printer or other printing device. If the user chooses to print the work, the present invention will interact with the display device and, if printing services are available, provide a printing of the work.

In an embodiment, the present invention provides a method for allowing a single user to create, store, and edit profile information for multiple individuals from a single user account. The present invention further provides a method for copying and storing single individual profiles to additional profile instances. For example, a user profile comprising a single profile representing an individual may copy that single profile so it may be applied to multiple customized works.

Methods of the present invention may be advantageously implemented over a network, such as the Internet or World Wide Web, using computer hardware and software.

In a further aspect, the present invention provides works. In an embodiment, a work of the present invention comprises content relating to a recipient of the work. The content may comprise one or more of the factors described above with reference to a system of the present invention. A work of the present invention may be advantageously produced using a method of the present invention, however the works of the present invention are not limited to works created by a method of the present invention, but rather include works produced by different methods.

Embodiments of the present invention are advantageous for use in the education, training and/or entertainment of children and/or adults. In embodiments, the present invention allows for the creation of works that place the recipient of the education, training or entertainment within the work, and/or simulate the environment of the recipient of the work. As such the recipient of the work material can “see” themselves performing the tasks/skills to be acquired as part of the education/training or entertainment or work.

Further embodiments of the present invention are advantageous for creating works to be used as entertainment of children and/or adults. In various embodiments, the present invention allows for the creation of works that place the profiled individual within an entertaining story. In another embodiment, the present invention may place the profiled individual within an entertaining video game. In these described embodiments and others not described, the profiled individual is able to “take part” in the entertaining story, video, or video game as a key element of such story, video, or video game.

In a further aspect, the present invention provides computer readable media.

In an embodiment, computer readable media of the present invention comprise program code for implementing a method of the present invention. In another embodiment, computer readable media of the present invention comprise program code that interacts with a system of the present invention.

The foregoing introduction is provided to introduce the reader to the general subject matter of the application. The invention described herein is not limited, and should not be construed as limited to such subject matter. Additional features and advantages of the present invention and embodiments of the present invention are set forth in the following paragraphs.

### BRIEF DESCRIPTION OF THE DRAWINGS

FIG. 1 is a diagram illustrating an example of an environment in which an embodiment of the present invention may operate.

FIG. 2 is a block diagram providing the steps of a method according to one embodiment of the present invention.

FIG. 3 is a block diagram providing the steps of determining relevant information according to one embodiment of the present invention.

FIG. 4 is a block diagram providing the steps of delivering a customized work to the user according to one embodiment of the present invention.

FIG. 5 is a visual representation of the method followed in the selection of certain information blocks for certain spaces in a template according to one embodiment of the present invention.

FIG. 6 is a visual representation of the template after the information blocks have been selected and inserted into the template according to one embodiment of the present invention.

FIG. 7 is the title page of a sample work resulting from an embodiment of the present invention showing a static illustration and static text.

FIG. 8 is the first page of a sample work resulting from an embodiment of the present invention showing a variable illustration, variable text, and static text.

FIG. 9 is the second page of a sample work resulting from an embodiment of the present invention showing a static illustration and static text.

FIG. 10 is the third page of a sample work resulting from an embodiment of the present invention showing a static illustration and static text.

FIG. 11 is the fourth page of a sample work resulting from an embodiment of the present invention showing a variable illustration and static text.

FIG. 12 is the sixth page of a sample work resulting from an embodiment of the present invention showing a variable illustration and variable and static text.

FIG. 13 is the seventh page of a sample work resulting from an embodiment of the present invention showing a variable illustration and static text.

FIG. 14 is the eighth page of a sample work resulting from an embodiment of the present invention showing a variable illustration and static text.

FIG. 15 is a block diagram of an embodiment of a template comprising a plurality of pages, static text blocks, static illustration blocks, variable text blocks, and variable illustration blocks.

FIG. 16 is a representation of an embodiment of the present invention allowing the user to select whether the static and variable illustrations within the work will be substantially complete or require further customization by the user.

### DETAILED DESCRIPTION

As set forth above, the present invention provides systems, methods and computer readable media for creating; providing and/or distributing works.

In the description contained herein, reference is made to a user. A user may comprise the profiled individual a child; adult; educator; parent; counselor; sibling or other family member; other professionals, such as psychologists, speech therapists, behavior therapists, occupational therapists, social workers, administrators, doctors, dentists, hygienists, or any other professional or personal care giver; or any other like individual who will be creating, accessing, modifying, displaying, or viewing customized or personalized works. For example, a user may be a parent who creates a customized or personalized work for a child. The descriptions in this paragraph are not meant to be exhaustive and a user may comprise other types of individuals or actions.

In the description contained herein, reference is made to a profiled individual. A profiled individual may comprise any individual person, real or fictional, about whom customized or personalized information will be gathered to create a customized or personalized work. In an embodiment, a profiled individual may enter his or her own customized or personalized information. In another embodiment, the customized or personalized information relating to a profiled individual may be entered by someone other than the profiled individual.

In the description contained herein, reference is made to a user profile or user account. A user profile or user account refers to a collection of data pertaining to a user of the present invention. Such information may include personal information, payment information, subscription information, as well as one or more stored individual profiles relating to profiled individuals. For example, the parent of several children may maintain a user profile in which the parent's subscription and billing information is aggregated, as well as stored information relating to each of the parent's children. A user profile may also include functionality to allow the user to perform tasks such as copying or editing information or one or more individual's profiles.

In the description contained herein, reference is made to an individual's profile. An individual's profile refers to an aggregation of data pertaining to customizable or personalizable information about a profiled individual that may be used to populate a customized or personalized work. For example an individual's profile may comprise data relating to the profiled individual's name.

In the description contained herein, reference is made to a template field or template fields. A template field is a portion of a template that is capable of being populated by an individual's profile information. For example, a template field may be capable of being populated by an individual's profile information that comprises a profiled individual's name. In another example, a template may be capable of being populated by an illustration selected based on profiled information, such as hair color.

In the description contained herein, reference is made to static data, variable data, and formatting data. Static data is data that may be inserted into works, but is not customizable or personalizable by the user. Variable data is data that may be inserted into works and contains data that is customizable or personalizable by the user. References to specific types of static data, such as static text, would refer to text data that is not customizable or personalizable by the user. References to specific types of variable data, such as variable audio, would refer to audio data that is customizable or personalizable by the user. Formatting data is data that specifies the arrangement of template fields within the work.

In the description herein, reference may be made to information blocks. An information block is an aggregation of data to be inserted into the field or plurality of fields comprising a template. An information block comprises at least one piece of data. In an embodiment, an information block may comprise one or more pieces of static data. In another embodiment, an information block may comprise one or more pieces of variable data. In a further embodiment, an information block may comprise one or more pieces of static data and one or more pieces of variable data.

In an embodiment the present invention provides a method for providing works with customized information, comprising the steps of: providing a template for works containing at least one portion of customizable information; populating the template with at least one of a plurality of information blocks. The method may further comprise the steps of: determining which information block or plurality of information blocks is desired by a user; and delivering the template containing the desired one information block or plurality of information blocks to the user.

A method of the current invention may comprise the step of creating a template or plurality of templates. A template of static or variable length may be created for a work with one or a plurality of fields within the template containing data. Such data may comprise fields of data that contain static data including, but not limited to, static text, static illustrations, static audio, static video, or other types of static data that may be perceived by the user. Such data may also comprise fields of data that contain variable data including, but not limited to, variable text, variable illustrations, variable audio, variable video, or other types of variable data that may be perceived by the user. Such data may also comprise other data that is not perceivable by the user, such as formatting data describing the placement of static or variable data fields within the work; data describing whether a field contains static or variable data; data describing whether the template comprises a written work, an audio/visual work, or other type of work; data describing the number of pages, if the template comprises a written work; or other data that may be needed to format the work.

In another embodiment, the template may contain a field or a plurality of fields comprising only static data. In a further embodiment, the template may contain a field or plurality of fields comprising only variable data.

A method of the present invention may further comprise the step of collecting profile information from the user. A question or plurality of questions may be posed to the user such that the user supplies information relating to one or more factors about the profiled individual. Such factors may include the factors discussed above. Such factors may include other factors, such as the profiled individual's age, favorite activity, or other customizable or personalizable information. In an embodiment, the user may supply information relating to one or more factors relating to a single profiled individual. In another embodiment, the user may supply information relating to a plurality of profiled individuals. For example, a parent user may supply information relating to his or her child and his or her child's friends to create a customized or personalized work relating to his or her child and his or her child's friends.

In an embodiment, the information gathered from the user about the profiled individual is stored in a profile. The data stored in the profile may be aligned with data required by a template or a plurality of templates that may be requested by the user. In an embodiment, a template requested by the user may comprise a variable data field requesting information not stored in one or more profiles requested by the user. The present invention may be capable of requesting the missing information from the user. The present invention may further be capable of storing the requested information in the profile.

In an embodiment the template for a written work and the plurality of information blocks are stored on at least one database server. The written work and the plurality of information blocks may be stored on the same database server or on separate database servers.

In another embodiment, the present invention may pose questions to the user that may be linked to fields in a template. In another embodiment, the present invention may pose questions to the user that may not be linked to fields in a template.

In an embodiment of a method of the present invention, determining which information block or plurality of information blocks is desired by a user comprises the steps of: reading the individual's profile information collected from the user; comparing the individual's profile information to template fields; selecting individual's profile information that matches the template fields; and requesting or prompting for information from the user if none exists.

In another embodiment of the method of the present invention, determining which information block or plurality of information blocks is desired by a user comprises the steps of: reading the individual's profile information collected from the user; comparing the individual's profile information to characteristics of an illustration or plurality of illustrations; selecting an illustration or plurality of illustrations that match the characteristics of the individual's profile information; comparing the selected illustration or plurality of illustrations to the template fields; and further selecting from the selected illustration or plurality of illustrations, those illustration or plurality of illustrations that match the template fields.

In an embodiment, delivering the template and the desired information block or plurality of information blocks to the user comprises the steps of: retrieving the template and the desired at least one information block from the database server or plurality of database servers; transmitting the template and the desired information block or plurality of information blocks over a network; and receiving the template and the desired information block or plurality of information blocks at a display device. The display device may comprise a computer, a personal digital assistant, or other electronic device. The display device may also, or further, comprise a printer. The network may comprise the database server and a personal computer, and may further comprise, or alternatively comprise a web server and the Internet. In an embodiment the template and the desired information block or plurality of information blocks are transmitted from the database server to the web server and from the web server to the personal computer via the Internet. In another embodiment, a template and an information block or plurality of information blocks are transmitted from the database server to a personal computer via a network.

A method of the present invention may further comprise storing user profile information in a storage medium. The user profile information comprises the user profile information collected from the user and may further comprise information identifying products previously purchased by the user. The user profile information or portions thereof in the storage medium may be updated periodically without any new input from the user. In an embodiment, a method of the present invention may comprise the step of contacting the user at various time intervals to request updated user profile information. A user may be offered products for sale based on the profile information.

A system of the present invention comprises computer hardware, software and/or firmware sufficient to perform a method of the present invention.

Computer readable media of the present invention comprises programmable computer code for implementing steps of a method of the present invention.

The present invention also provides works. In an embodiment, a work of the present invention comprises a template. The template comprises at least one information block including information received from an individual. The template may comprise an audio-visual template, a written template, an illustrated template, or something similar.

A work of the present invention may be substantially complete, or may be in a form that allows for further customization by a user. For example, a work of the present invention may comprise line drawings that allow for illustration by a user. In another example, a work of the present invention may comprise illustrations that have already been colored so no further action by the user is needed. In a further example, textual portions may be left blank for further customization.

The appended Figures provide schematic overviews of some embodiments of methods and systems of the present invention. It will be understood that each element of the illustrations, and combinations of elements in the illustrations, in the Figures, can be implemented by general and/or special purpose hardware-based systems that perform the specified functions or tasks, or by combinations of general and/or special purpose hardware and computer instructions (or computer program code). Some embodiments of the present invention relate to a computer-readable medium, having computer-readable instructions or computer program code for performing the specified functions, tasks, or steps.

This computer program code can be provided to a processor to produce a machine, such that the program code that executes on the processor creates means for implementing the functions and tasks specified in the illustrations. The computer program code can be executed by a processor to cause a series of operational steps to be performed by the processor to produce a computer implemented process such that the code which executes on the processor provides steps for implementing the functions and tasks specified in the illustrations and/or text. Accordingly, the description contained herein and the Figures support combinations of means for performing the specified functions, combinations of steps for performing the specified functions, and computer program code for performing the specified functions.

It will be understood that systems, methods and computer program products according to the present invention can be advantageously implemented as a stored computer software program that executes on a data processing system. Any such system can be used. In some embodiments, a legacy data processing system, such as an IBM Model S/390 can be used. In some embodiments, midrange or personal systems, or a network of legacy, midrange and personal systems, are used.

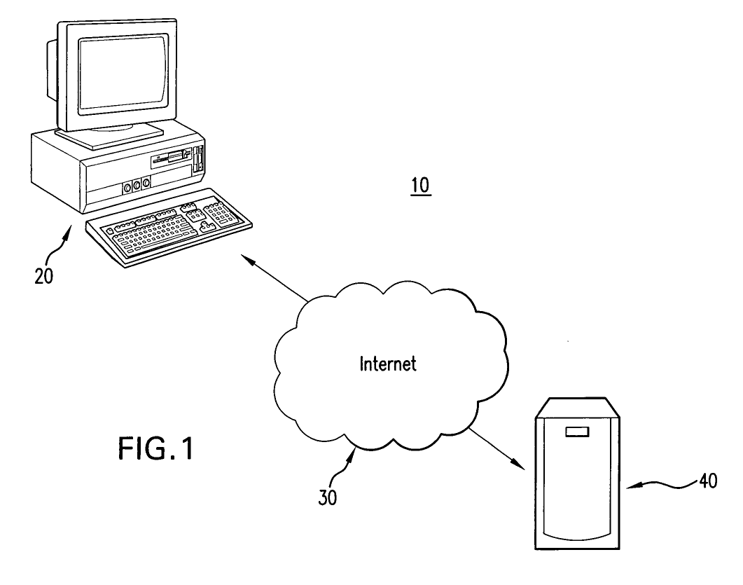

Referring now to FIG. 1, an embodiment of the present invention involves delivering customized information to a user over a computer network 10. The system shown comprises a client device 20 in communication with a server device 40 over a network 30. The network 30 shown comprises the Internet. In other embodiments, other networks, wired and wireless, such as an intranet, local area network, wide area network, or broadcast network may be used. Moreover, methods according to the present invention may operate within a single client or server device.

A client device may comprise a computer-readable medium, such as a random access memory (RAM) in communication with a processor. The processor executes computer-executable program instructions stored in the memory. Such processors may comprise a microprocessor, an ASIC, or state machines. Such processors comprise, or may be in communication with, media, for example computer-readable media, which stores instructions that, when executed by the processor, cause the processor to perform operations, such as those described herein.

Embodiments of computer-readable media include, but are not limited to, electronic, optical, magnetic, or other storage or transmission devices capable of providing a processor with computer-readable instructions. Other examples of suitable media include, but are not limited to, a floppy disk, CD-ROM, DVD, magnetic disk, memory chip, ROM, RAM, an ASIC, a configured processor, optical media, magnetic tape or other magnetic media, or any other suitable medium from which a computer processor can read instructions. Also, various other forms of computer-readable media may transmit or carry instructions to a computer, including a router, private or public network, or other transmission device or channel, both wired and wireless. The instructions may comprise code from any suitable computer-programming language, including, for example, HTML, XML, Net, ASP, C, C++, C#, Visual Basic, VBScript, Java, Python, Perl, and JavaScript.

Client devices may also comprise a number of external or internal devices such as a mouse, a CD-ROM, DVD, a keyboard, a display, or other input or output devices. Examples of client devices are personal computers, personal digital assistants, cellular phones, mobile phones, smart phones, pagers, digital tablets, laptop computers, Internet appliances, and other processor-based devices. In general, a client device may be any type of suitable processor-based platform that is connectable to a network and that interacts with one or more application programs. Client devices may operate on any operating system, such as Microsoft® Windows®, Linux, or Mac®OS. The client device shown includes, for example, personal computers executing a browser application program such as Microsoft Corporation's Internet Explorer™, Mozilla Foundation's Firefox™, or Apple Computer, Inc.'s Safari™.

Similar to the client devices the server comprises a processor coupled to a computer-readable memory. The server may be in communication with a data store. The server may comprise a single computer system and/or may be implemented as a network of computer processors. Examples of servers include mainframe computers, networked computers, a processor-based device, and similar types of systems and devices. Client processor and the server processor can be any of a number of computer processors, such as processors from Intel Corporation of Santa Clara, Calif. and Motorola Corporation of Schaumburg, Ill. In an embodiment, the server and the client may be the same device and a network comprising the server and client device may comprise the device's internal communication networks including, but not limited to, memory buses, device buses, shared memory, shared permanent storage media, or others.

It should be noted that this invention may comprise systems having different architecture. The system shown in FIG. 1 is merely an example of a suitable system, and is used to help explain the methods illustrated in the remaining Figures.

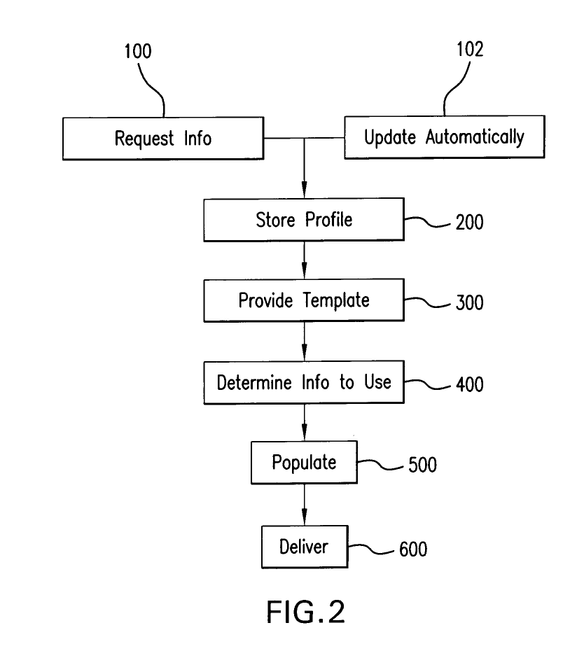

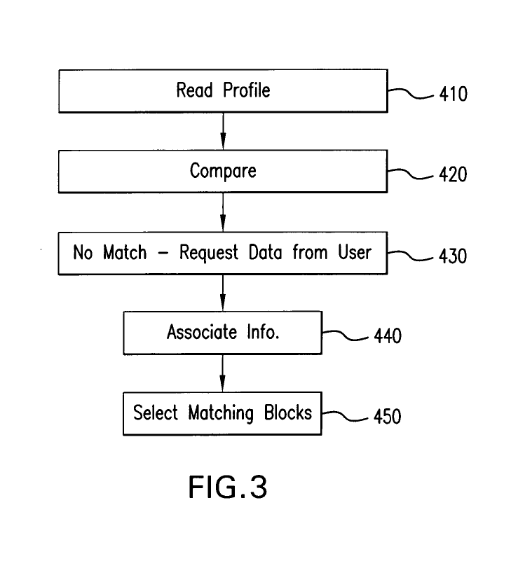

Referring now to FIG. 2, an embodiment of the present invention comprises the steps of requesting customized or personalized information from the user 100 and/or automatically updating customized or personalized information 102, storing the customized or personalized information in an individual profile 200, providing a template for the work 300, determining which of the customized or personalized information blocks to use 400, and populating 500 the template with at least one of a plurality of information blocks. Referring now to FIG. 3, the method may further comprise the steps of reading profile information 410, comparing the profile information 420 with information blocks, and if no matching information block is found, requesting data from the user 430. The profile information can be collected 430 from the user by asking questions of the user and recording the responses. The profile information also can be collected 100 by recording the selections that the user makes on a website. The method may further comprise the step of associating 440 each of the plurality of information blocks with profile factors. The profile factors can be associated 440 with particular information blocks before or after the information blocks are stored in the database server. The profile factors indicate which information blocks contain information relating to certain elements of a profile. In one embodiment, the step of determining 400 which at least one information block is desired by a user comprises the steps of reading 410 the profile information; comparing 420 the profile information to the profile factors associated 440 with each of the plurality of information blocks; and selecting 450 all information blocks associated 440 with profile factors that are exact matches.

Examples of specific profile factors, information blocks and questions designed to generate factors from or about a user and/or a profiled information are set forth above and in matrix set forth in the following table.

| | | | | Daily | | | |
|---|---|---|---|---|---|---|---|
| | | | | Routines & | | | |
| Physical | Personal | Feelings | Social | Rules | Safety | Seasonal | Health |
| Information | Information | Information | Information | Information | Information | Information | Information |
| Gender | Child's name | Something | Something | What is the | Something | What | The kind of |
| | | that makes | the child | name of the | the child | holidays | bathing the |
| | | the child | does with | grocery store | likes and | does your | child does |
| | | happy | their hands | you | would be | family | |
| | | | that you are | frequently | tempted to | celebrate | |
| | | | working to | visit | go with a | | |
| | | | decrease or | | stranger to | | |
| | | | stop | | have | | |
| Glasses | Child's | A specific | An | Art teacher's | A place the | What are | Doctor's |
| | favorite food | thing that | alternative | name | child would | some | name |
| | | makes the | behavior to | | be tempted | holiday | |
| | | child | the child | | to go with a | family | |
| | | anxious | specific | | stranger | traditions | |
| | | | hand | | | | |
| | | | behavior | | | | |
| | | | you are | | | | |
| | | | trying to | | | | |
| | | | decrease | | | | |
| Eye color | Name of | A strategy | A bad word | Physical | The child's | Who is | Who will go |
| | child's school | you would | or phrase the | education | or familiar | usually at | with the |
| | | like the child | child uses to | teacher's | pet's names | the holiday | child to the |
| | | to use when | describe | name | | functions | doctor's |
| | | anxious | people or | | | | office |
| | | | things other | | | | |
| | | | than stupid | | | | |
| | | | and ugly | | | | |
| Skin color | Adults who | Specific | A positive | Music | Toys or | Who and | Times other |
| | regularly give | thing the | thing the | teacher's | treats the | what the | than before |
| | the child | child fears | child could | name | child can use | party is for | eating, after |
| | directions to | | say about | | to play with | | using the |
| | follow | | himself to | | or give to a | | restroom, or |
| | | | peers | | known pet | | after |
| | | | | | | | touching |
| | | | | | | | something |
| | | | | | | | dirty that |
| | | | | | | | you would |
| | | | | | | | like the child |
| | | | | | | | to wash their |
| | | | | | | | hands |
| Hair style | Teacher's | The strategy | An | Bus driver's | Behavior | Where the | A specific |
| | name | you would | alternative | name | you would | party is | thing the |
| | | like the child | to a | | like the child | being held | child is |
| | | to use to | swearword | | to | | working on |
| | | cope with | that the child | | demonstrate | | for self-care |
| | | the fear | could use | | when they | | |
| | | mentioned | when angry | | see an | | |
| | | above | or frustrated | | unfamiliar | | |
| | | | | | animal | | |
| Hair color | Where the | Specific | A word or | School | Where the | Who the | The reason |
| | child lives | thing that | phrase the | principal's | child goes | child gives | the child |
| | | frustrates the | child uses | name | when there | gifts to | should use |
| | | child | that you are | | is a fire or | | the child- |
| | | | trying to | | fire drill | | specific self |
| | | | prevent | | | | care above |
| Communication | Child's | The strategy | An | People the | Who | Activities | The word |
| method | favorite toy | you would | alternative | child listens | accompanies | the child can | you use |
| | | like the child | to the word | to at school | the child to | participate | when |
| | | to use to | to phrase | | the safe | in at the | discussing |
| | | cope with | above | | place | party | the |
| | | their specific | | | | | bathroom |
| | | frustration | | | | | |
| Friend's gender | The name of | Something | Activity the | People in the | Things the | Where the | The gender |
| | one of the | that makes | child enjoys | home who | child might | child is | and wording |
| | child's | the child | and could | ask the child | want to take | going on a | of the |
| | friends | angry | ask others to | to do things | when | field trip | bathroom |
| | | | join | | evacuating | | the child |
| | | | | | but is not | | will use |
| | | | | | able to | | |
| | | | | | retrieve | | |
| Friend's glasses | The child's | A strategy | Something | A specific | The | What items | The word |
| | favorite | you would | the child | time you | behaviors | the child is | you use to |
| | clothing | like the child | does alone | would like | the child | bringing on | discuss |
| | | to use to | | the child to | should | the field trip | urination |
| | | cope with | | listen | demonstrate | | |
| | | what makes | | | once | | |
| | | them angry | | | evacuated | | |
| | | | | | and in the | | |
| | | | | | safe place | | |
| Friend's eye | Child's | How the | A strategy | A | Other things | What the | The word |
| color | friends' | child shows | you would | community | the child | child will | you use to |
| | names | they are | like the child | place the | should do | see while on | discuss |
| | | happy | to use if they | child goes | when | the field trip | defecation |
| | | | do not get | frequently | encountering | | |
| | | | what they | | a drill or | | |
| | | | want then | | natural | | |
| | | | working | | disaster | | |
| | | | with others | | | | |
| Friend's skin | Grade the | Something | People the | Directions | Coping | Specific | A specific |
| color | child is in | that makes | child works | the child has | strategy for | behavior | concern or |
| | | the child sad | or plays with | trouble | the child to | you would | behavior |
| | | | in the home | following at | handle any | like to see | you would |
| | | | | home | anxiety felt | the child | like to child |
| | | | | | during the | demonstrate | to |
| | | | | | drill | on the field | demonstrate |
| | | | | | | trip | in the |
| | | | | | | | restroom |
| Friend's hair | Child's age | Something | Activities | Directions | An area of | Place the | Child's |
| style | | that makes | the child | the child is | the | child is | dentist's |
| | | the child | does in the | learning to | playground | going on | name |
| | | mad | home with | follow at | that is | vacation | |
| | | | other people | school | especially | | |
| | | | | | dangerous | | |
| | | | | | for the child | | |
| Friend's hair | Child's | Specific | Who the | A place the | Behavior | The names | Who will go |
| color | bedtime | subject the | child plays | child goes to | you would | of the people | to the dentist |
| | | child has | games with | other than | like the child | going on the | with the |
| | | trouble | | school or | to | vacation | child |
| | | taking tests | | home where | demonstrate | | |
| | | in | | they | in this area | | |
| | | | | experience | | | |
| | | | | changes | | | |
| Friend's | Profile name | Strategies | A specific | A small | People who | Where the | Child's hair |
| communication | | you want the | situation you | change the | monitor or | child will | stylist's |
| method | | child to use | would like | child | go to the | stay on | name |
| | | when they | the child to | regularly | playground | vacation | |
| | | have | be more | encounters | to care for | | |
| | | difficulty | honest | | the child | | |
| | | taking tests | during the | | | | |
| | | | day | | | | |
| | School | | A specific | The strategy | The child's | How long | Who will go |
| | setting | | aspect of | you would | favorite | the child is | to the stylist |
| | | | showing | like to see | thing to do | going on | with the |
| | | | respect that | the child use | on the | vacation | child |
| | | | you are | when the | playground | | |
| | | | working on | small change | | | |
| | | | with the | happens | | | |
| | | | child | | | | |
| | Home setting | | People the | A big change | Time the | Things they | Where the |
| | | | child should | the child is | child usually | will do | salon is |
| | | | show respect | experiencing | goes to the | while on | located |
| | | | to at home | | playground | vacation | |
| | Child's | | People the | The strategy | | Name of the | Behavior |
| | background | | child should | you would | | child's camp | you would |
| | or ethnicity | | show respect | like the child | | | like the child |
| | | | to at school | to use to help | | | to |
| | | | | them adapt to | | | demonstrate |
| | | | | the new | | | at the |
| | | | | situation | | | stylist's |
| | | | Choices the | How the | | Activities to | Sickness or |
| | | | child | classroom | | do at camp | sick feeling |
| | | | frequently | rules are | | | the child |
| | | | has to make | presented | | | frequently |
| | | | at home | | | | experiences |
| | | | Choices the | The | | Things the | Medicines |
| | | | child | classroom | | child takes | or behavior |
| | | | frequently | rules | | with them to | you would |
| | | | has to make | | | camp | like the child |
| | | | in the | | | | to use when |
| | | | community | | | | feeling sick |
| | | | Places the | Other | | How long | Something |
| | | | child goes in | classroom | | the child | familiar the |
| | | | the | rules | | will be at | child can do |
| | | | community | | | camp | or hold to |
| | | | where they | | | | feel |
| | | | have to | | | | comfortable |
| | | | make | | | | or happier |
| | | | choices | | | | when sick |
| | | | Choices the | The positive | | Names of | |
| | | | child | consequences | | other people | |
| | | | frequently | the child | | at the camp | |
| | | | has to make | receives for | | | |
| | | | at school | following the | | | |
| | | | | rules | | | |
| | | | Positive | The school | | | |
| | | | reward for | rules | | | |
| | | | making | | | | |
| | | | good | | | | |
| | | | choices | | | | |
| | | | Sport the | Other school | | | |
| | | | child plays | rules | | | |
| | | | Child's | Where the | | | |
| | | | coach's | child gets the | | | |
| | | | name | bus | | | |
| | | | Where the | Who the | | | |
| | | | sport is | child waits | | | |
| | | | played | with to get | | | |
| | | | | on the bus | | | |
| | | | Behavior | How the | | | |
| | | | you would | child stays | | | |
| | | | like the child | safe waiting | | | |
| | | | to | for the bus | | | |
| | | | demonstrate | | | | |
| | | | while | | | | |
| | | | playing the | | | | |
| | | | sport | | | | |
| | | | Names of | Where the | | | |
| | | | some of the | child should | | | |
| | | | other | go after | | | |
| | | | children on | exiting the | | | |
| | | | the team | bus | | | |
| | | | | Bus rules | | | |
| | | | | besides using | | | |
| | | | | an inside | | | |
| | | | | voice, | | | |
| | | | | wearing a | | | |
| | | | | seatbelt, and | | | |
| | | | | staying in | | | |
| | | | | your seat | | | |
| | | | | Activity that | | | |
| | | | | often has to | | | |
| | | | | be | | | |
| | | | | interrupted or | | | |
| | | | | finished | | | |
| | | | | immediately | | | |
| | | | | before | | | |
| | | | | bedtime | | | |
| | | | | Unique part | | | |
| | | | | of the child's | | | |
| | | | | routine | | | |
| | | | | immediately | | | |
| | | | | before going | | | |
| | | | | to bed | | | |
| | | | | Chores the | | | |
| | | | | child does at | | | |
| | | | | home | | | |
| | | | | What | | | |
| | | | | materials or | | | |
| | | | | devices the | | | |
| | | | | child needs | | | |
| | | | | to do their | | | |
| | | | | chores | | | |
| | | | | What rooms | | | |
| | | | | the chores | | | |
| | | | | are | | | |
| | | | | completed in | | | |
| | | | | Reward for | | | |
| | | | | completing | | | |
| | | | | chores | | | |

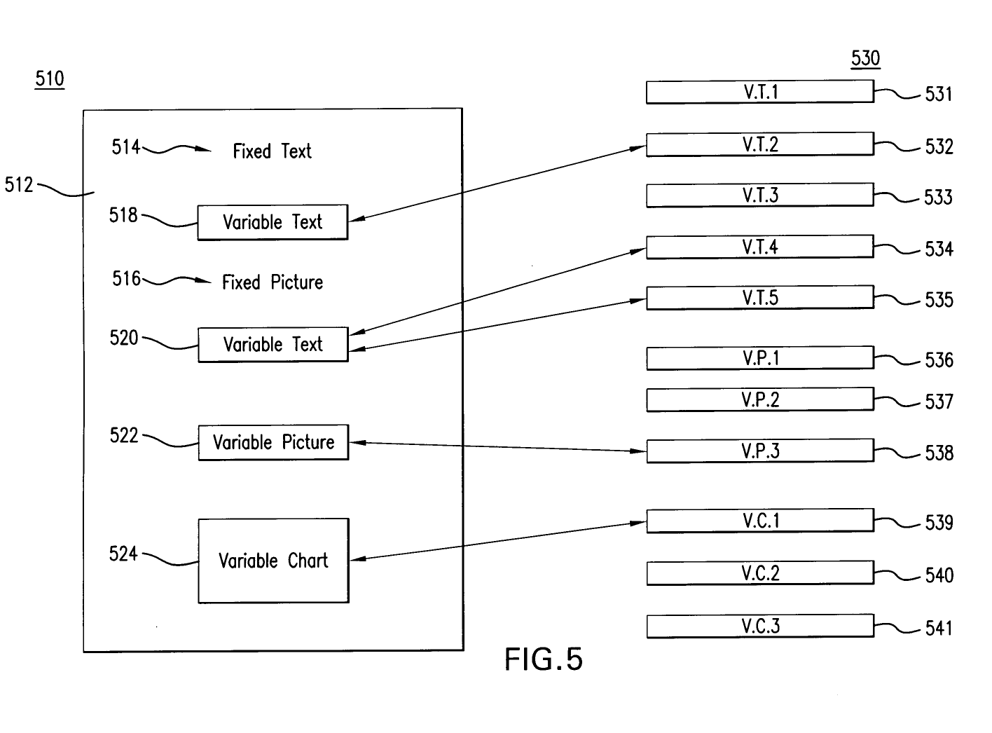

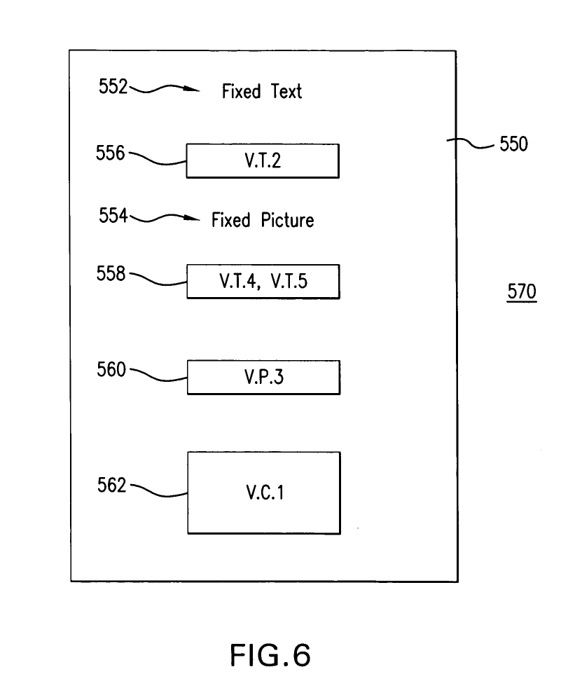

FIG. 5 provides an example of a customized document 510 comprising a template 512. The template 512 may contain some static text 514 and some static picture 516. The template 512 may also contain fields 518, 520, 522, 524 into which can be inserted variable text 518, 520, variable pictures 522, and variable charts 524, or graphics, audio files, video files, and any other communication medium. The template 512 for the works relates to a specific story. For example, one template 512 of works could relate to a story about the virtues of sharing. The spaces 518, 520, 522, 524 of the template 512 are populated by information blocks from the group 530 of information blocks made available for that template 512. In FIG. 5, there are information blocks for variable text 531-535, for variable pictures 536-538, and for variable charts 539-541. Referring now to FIGS. 5 and 6, the space 518 for variable text is populated by an information block 532 for variable text, creating a populated space 556. The space 520 for variable text is populated by two information blocks 534, 535 for variable text, creating a populated space 558. There need not be a one-to-one relationship between spaces and information blocks. The space 522 for variable picture is populated by an information block 538 for variable picture, creating a populated space 560. Finally, the space 524 for variable chart is populated by an information block 539 for variable chart, creating a populated space 562. In the example shown in FIG. 6, the template 550 containing static text 552, static picture 554, and populated spaces 556, 558, 560, 562 constitutes a completed customized document 570. A customized document may comprise any single information block or any combination of static items and variable items, in any communication medium.

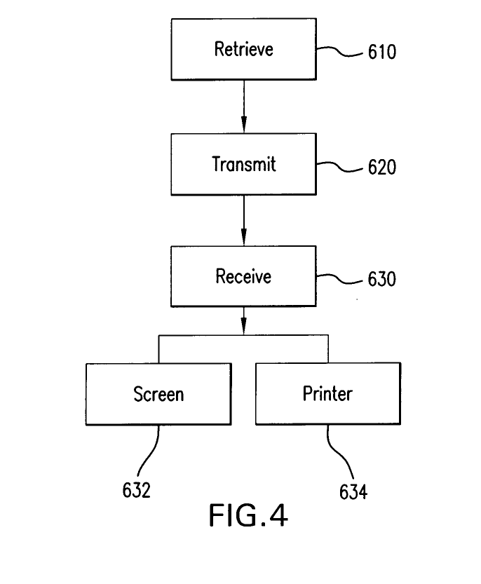

Referring now to FIGS. 3 and 4, when the appropriate information blocks have been selected 450 and inserted into the template, the template and information blocks could be retrieved 610 from the database and transmitted 620 over the network and received 630 at a display device. The display device could be a client device display screen 632, a printer 634, or any other display device. The template and information blocks could arrive as one data file, as a plurality of data files, as streaming data, or in any other manner.

Referring again to FIG. 2, another embodiment of the present invention further comprises the step of storing 200 the profile information collected from the user in a storage medium. The storage medium could be a computer hard drive, a database server, or any other storage medium. The stored profile information could be updated 102 without further input from the user. For example, if a user indicates that the profiled individual is six years old with a birthday of September 15, that information could be updated 102 on September 15 to indicate the profiled individual is seven years old, without any new input from the user. The profile information could also remain unaltered, in the event that the relevant information block refers to data that does not change, for example, the profiled individual's gender. A further embodiment of the invention could request the missing information 100 from the user.

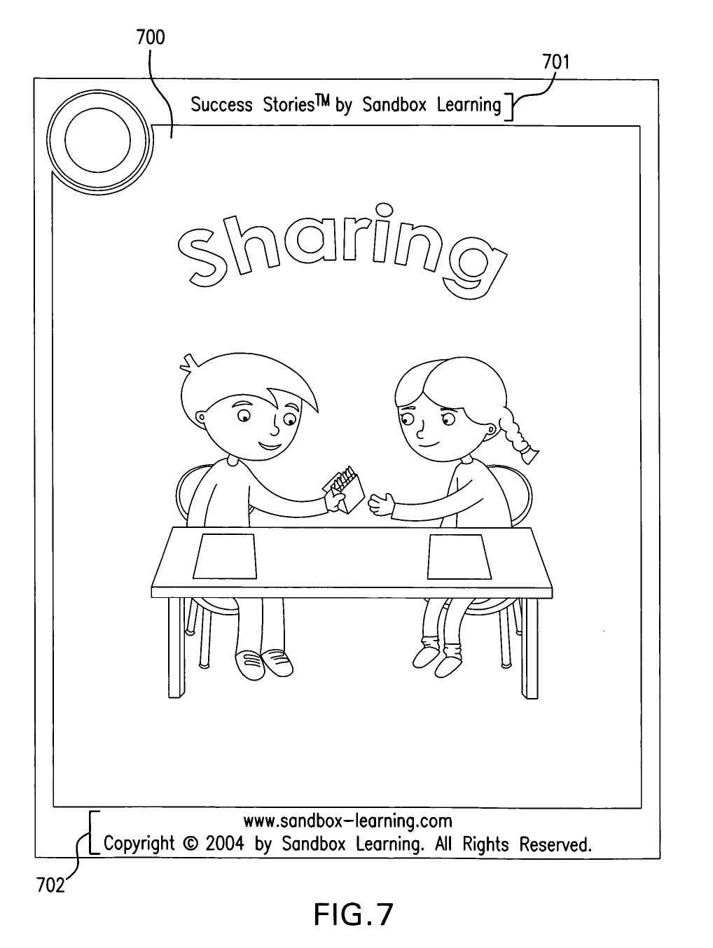

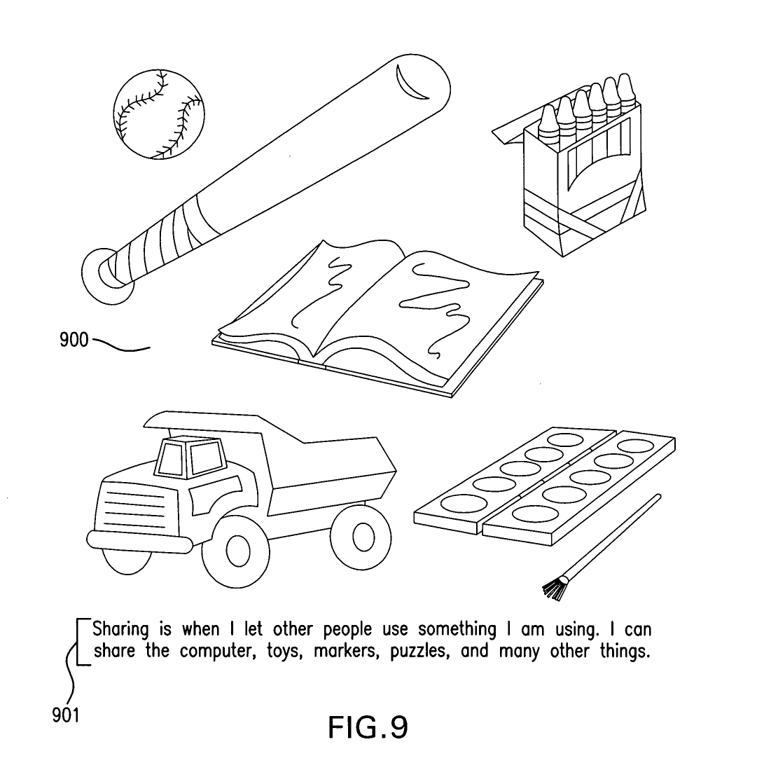

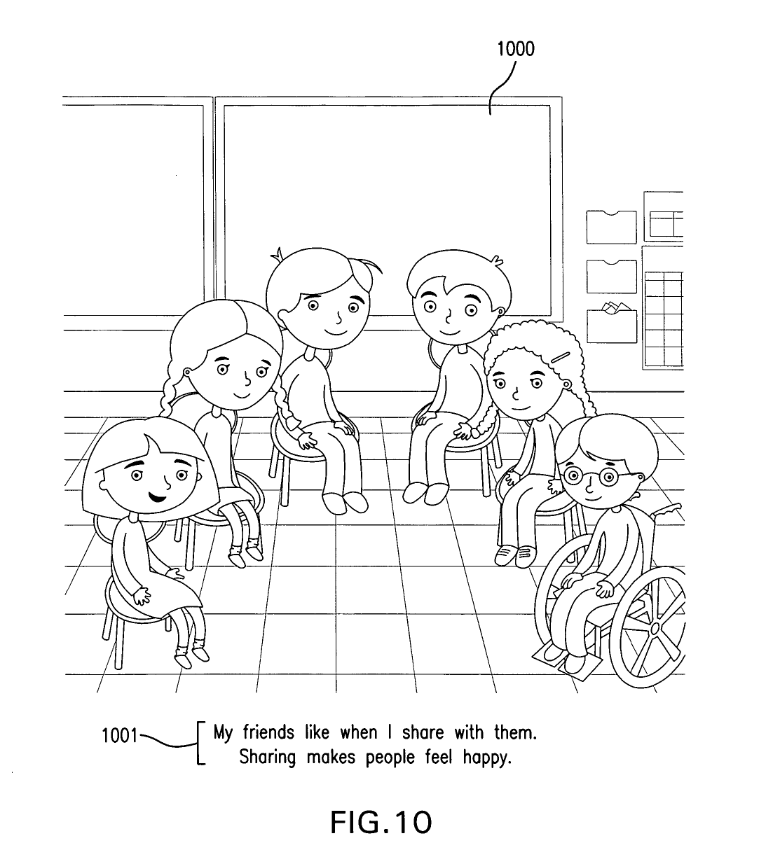

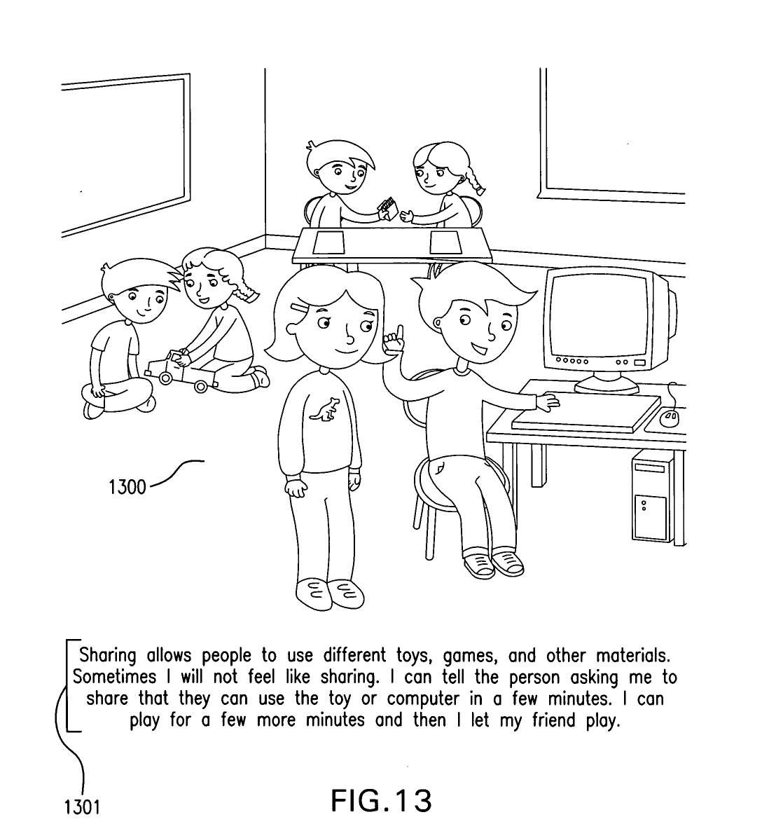

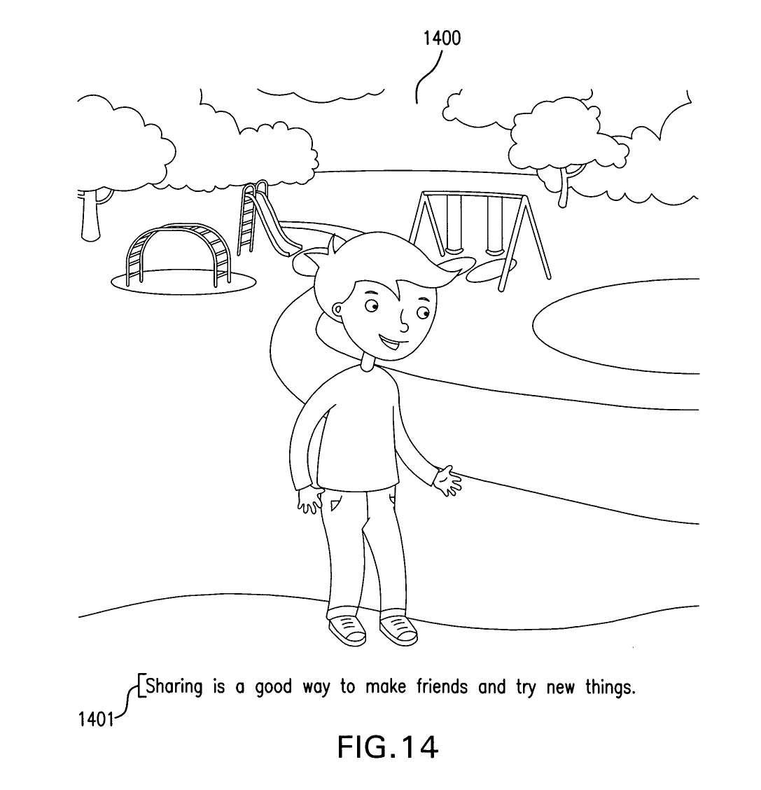

Referring now to FIGS. 7-14, another embodiment of the invention is a work that resulted from following the methods of an embodiment of the invention.

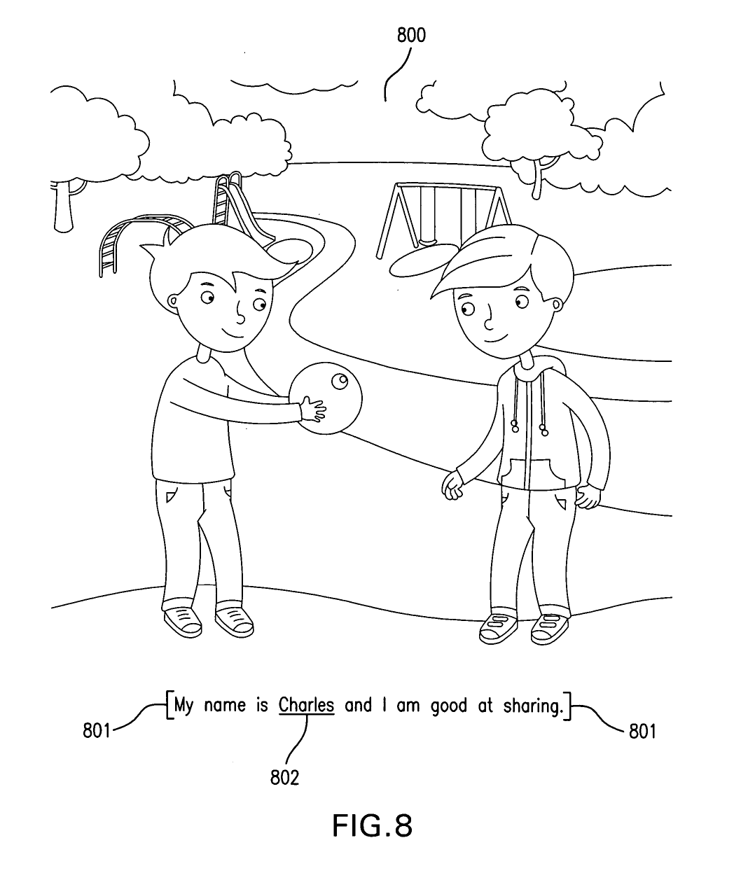

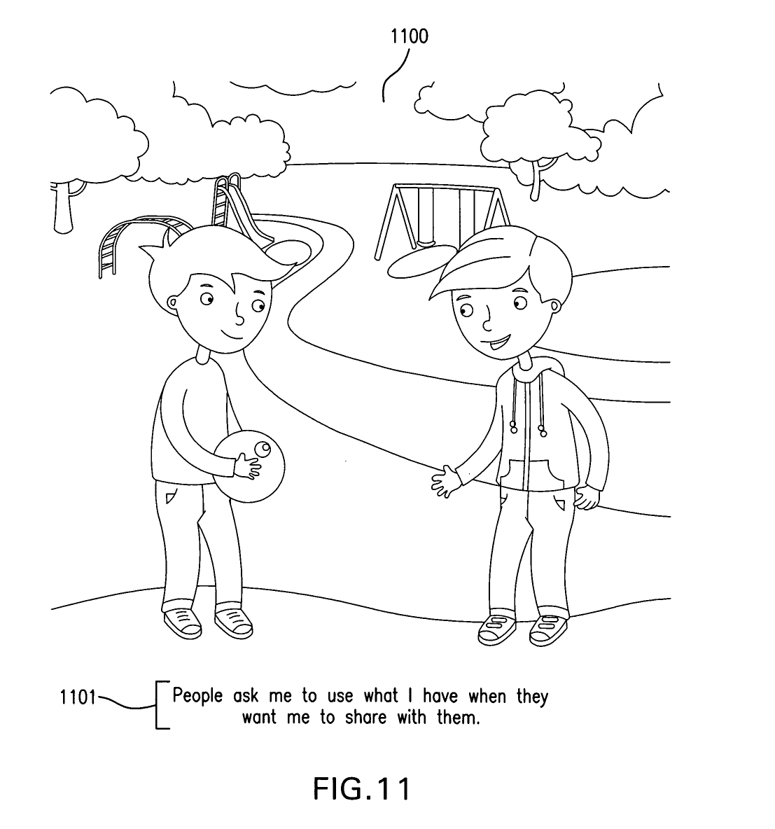

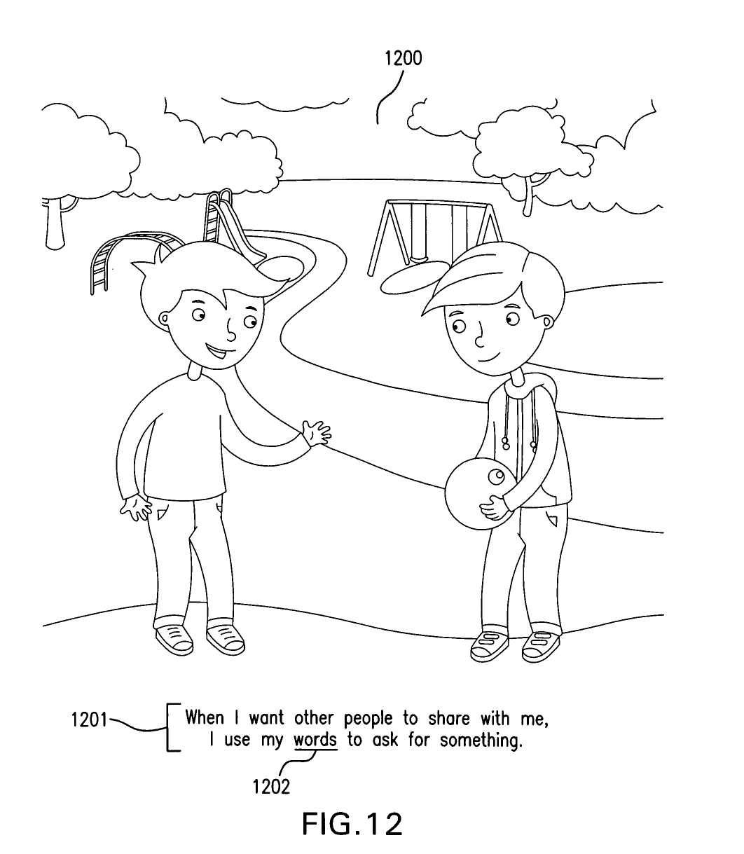

FIGS. 7-14 show the result of aligning a plurality of information blocks comprising static and variable information to a plurality of static and variable data fields comprising a template. FIGS. 7, 9, and 10 demonstrate the alignment of information blocks comprising a static illustration and information blocks comprising static text to corresponding fields within the template. FIGS. 7, 9 and 10 depict information blocks comprising static illustrations 700, 900, 1000 with information blocks comprising static text 701, 702, 901, 1001. The information blocks comprising static illustrations 700, 900, 1000 and information blocks comprising static text 701, 702, 901, 1001 do not change regardless of the profiled individual's stored customized and personalized information. FIGS. 8 and 12 depicts information blocks comprising a variable illustration 800, 1200 with an information block comprising static text 801, 1201 and variable text 802, 1202. The information blocks comprising the variable illustrations 800, 1200 were selected by aligning the profiled individual's gender, female, hair style, pony tail, and hair color, blonde, with the characteristics of illustrations stored in a database and selecting the illustration that matched the profile information. FIGS. 11, 13, and 14 depict information blocks comprising variable illustrations 1100, 1300, 1400 with information blocks comprising static text 1101, 1301, 1401. The information blocks comprising variable illustrations 1100, 1300, 1400 are selected based on the information stored in the profiled individual's profile. The information blocks comprising static text 1101, 1301, 1401 remain static regardless of the information stored in the profiled individual's profile.

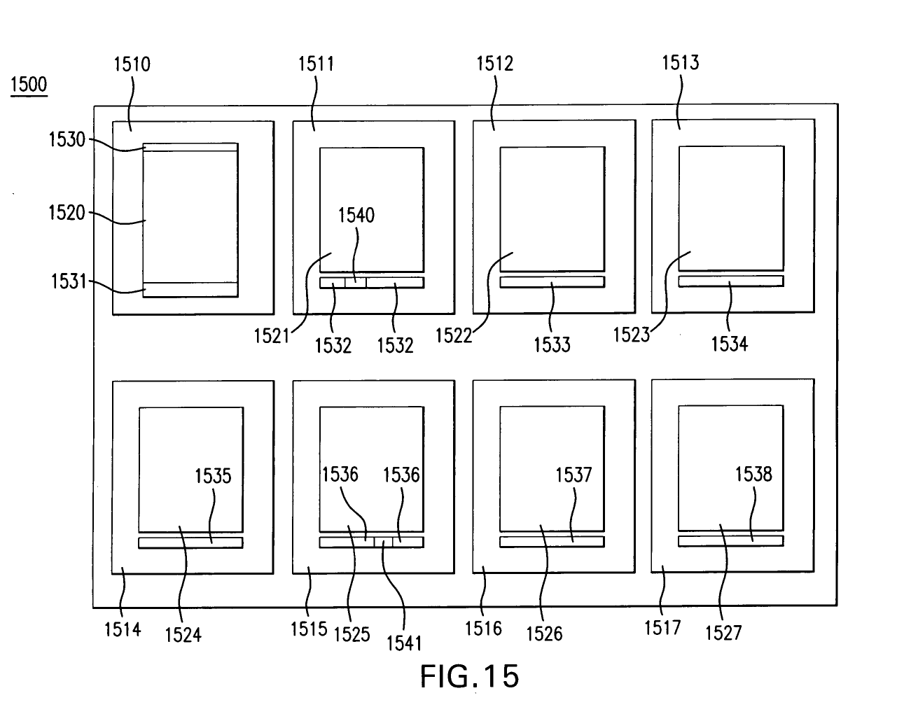

Referring now to FIG. 15, an embodiment of a template is shown. The template 1500 comprises formatting fields and data comprising pages of a story book 1510-1517 which is an embodiment of a template 1500 for the text and illustrations shown in FIGS. 7-14. The template further comprises various fields comprising static text, 1530-1538, static illustrations 1520, 1522, 1523, variable text 1540, 1541 and variable illustrations 1521, 1524-1527. The embodiment shown in FIG. 15 is merely an illustration of one embodiment. Another embodiment of a template may comprise static and variable data creating a single page of a work. A further embodiment may comprise static and variable data creating an audio/visual work.

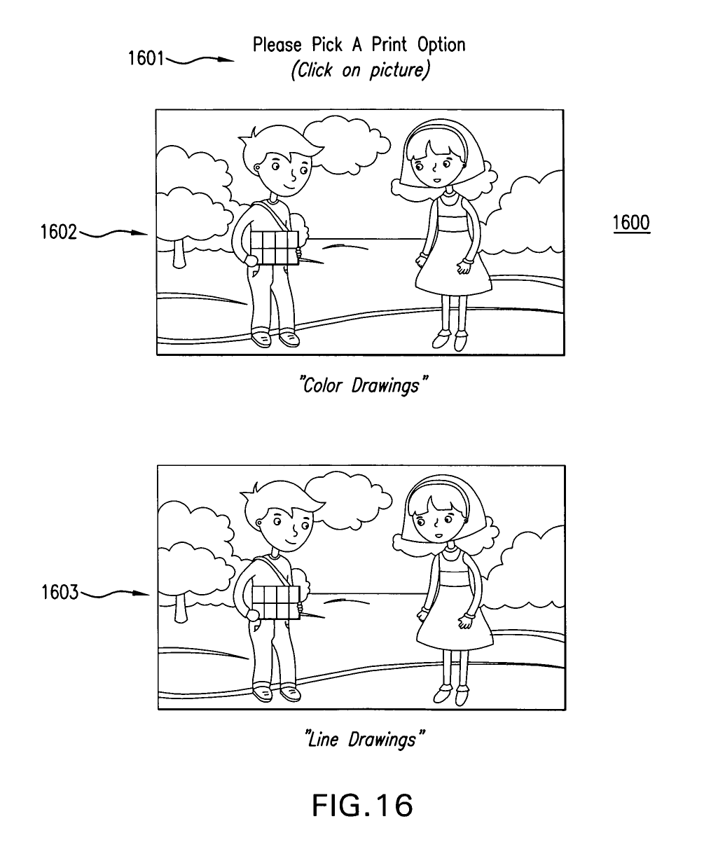

Referring now to FIG. 16, an embodiment of the present invention allowing printing by the user is shown. The selection method 1600 includes a fixed instruction to the user 1601 to select a printing style. The embodiment of the invention allows the user to select a printing style which displays a work that is either substantially complete 1602 or a work that requires further customization by the user 1603. In the embodiment shown, such further customization by the user 1603 comprises providing the user with line drawings that the user may illustrate to his or her taste after the work has been printed.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention. Other embodiments are possible and can be more practical for different applications.

What is claimed is:

1. A method for providing customized or personalized works comprising the steps of:
providing a template for works comprising one or more static or variable data fields capable of being populated;
obtaining customized or personalized information;
populating the one or more static or variable data fields with information to create a work.

2. The method of claim 1, further comprising the steps of:
determining at least one piece of information required by the template; and populating the template with the information.

3. The method of claim 2 further comprising determining a plurality of pieces of information required by the template and populating the template with the plurality of information.

4. The method of claim 1 wherein the customized or personalized information is stored in a database.

5. The method of claim 1 wherein the work is transmitted to a display device or printer.

6. The method of claim 1 wherein the template comprises a written work.

7. The method of claim 1 wherein the template comprises an audio-visual work.

8. A system for providing works comprising: a client device; a server; a network comprising the client device and the server; a template for a work resident on the server, the template containing at least one portion capable of being populated; wherein the server is capable of receiving input for populating the template from the client device via the network; and a display device.

9. The system of claim 8 wherein the network comprises the Internet or World Wide Web.

10. The system of claim 8 wherein the client device and server constitute the same device and the network comprises the internal communication channels of the device.

11. The system of claim 8 wherein the display device comprises a computer, a personal digital assistant, or another electronic device.

12. The system of claim 8 wherein the display device comprises a printer.

13. A work comprising: a template populated with customized or personalized information relating to an individual intended to receive the work.

14. Computer readable media for providing customized or personalized works comprising:
program code for providing a template for works comprising one or more static or variable data fields capable of being populated;
program code for obtaining customized or personalized information;
program code for populating the one or more static or variable data fields with information to create a work.

15. The computer readable media of claim 14 further comprising: program code for determining at least one piece of information desired by a user; and program code for populating the template with the information.
